(19) United States
(12) Patent Application Publication
(10) Pub. No.: US 2022/0064429 A1
(43) Pub. Date: Mar. 3, 2022

(54) THERMOSETTABLE CASTING COMPOSITION, MOLDING PRODUCED FROM IT, AND METHOD FOR PRODUCING THE MOLDING

(71) Applicant: Schock GmbH, Regen (DE)

(72) Inventors: Vitaliy DATSYUK, Zwiesel (DE); Adam ORENDORZ, Zwiesel (DE); Oskar ACHATZ, Bischofsmais (DE)

(21) Appl. No.: 17/398,392

(22) Filed: Aug. 10, 2021

(30) Foreign Application Priority Data
Aug. 25, 2020 (DE) 10 2020 122 216.5

(51) Int. Cl. C08L 33/12; A01N 65/44; A01N 65/22; A01N 65/24; A01N 65/08; A01N 65/28; A01N 25/10; A01N 25/34; A01P 1/00

(52) U.S. Cl. CPC C08L 33/12; A01N 65/44; A01N 65/22; A01N 65/24; A01N 65/08; A01N 65/28; C08L 2203/30; A01N 25/34; A01P 1/00; C08L 2205/025; C08L 2205/03; C08L 2207/32; A01N 25/10

(57) ABSTRACT

A thermosettable casting composition, with a polymeric binder and filler particles incorporated therein, where the casting composition includes at least one essential oil.

### CROSS-REFERENCE TO RELATED APPLICATIONS

The present application claims priority of DE 10 2020 122 216.5, filed Aug. 25, 2020, the priority of this application is hereby claimed, and this application is incorporated herein by reference.

### BACKGROUND OF THE INVENTION

The invention pertains to a thermosettable casting composition.

Human health is doubtless affected by microbial entities at home, at school, in the workplace, and in the environment in general. Viruses and bacteria cause a host of diseases which lead to long absences in schools and in the workplace. The appearances of new viruses, e.g., SARS-CoV-2, leads to serious, and even fatal, disorders. Among the public, there is increasingly a focus on the disinfection of people and property. Antimicrobial cleanliness is becoming more and more important in many areas of life and in many places.

Antimicrobial agents which are incorporated in the solid surface materials composed alternatively of an acrylic resin, an unsaturated polyester resin or an epoxy resin are described in WO 97/49761 (E. I. Du Pont de Nemours and Company). The use is described of inorganic particles, such as zinc oxide core particles, which have two surface coatings of the metal or of the metal compounds. The use of antimicrobial agents of this kind, however, may be expensive, resulting in high production costs for the end-use material.

Chitosan in combination with a solution of zinc sulfate, copper sulfate or silver nitrate is able to boost the antimicrobial activity of materials, as described in U.S. Pat. No. 7,381,715 B2 (E.I. Du Pont de Nemours and Company). Metal ions, such as Ag+, Cu2+, Zn2+, etc., exhibit antimicrobial properties, in comparison to bacteriostatic polymers, because of a different mode of action. Chitosan is a chelating agent and has a ready propensity to form complexes with transition metals and heavy metals. It has been shown (see Wang X., Du Y., Liu H (2004) Carbohydr. Polym 56:21) that the chitosan-Zn complex possesses a broad spectrum of antimicrobial activity, which is influenced by the chelation ratio. The influence of the property of metal ions, the molecular structural properties of chitosan, and environmental factors on the antimicrobial activity of chitosan-metal complexes has not, however, been entirely clarified.

Increasingly, kitchen articles or sanitary articles such as kitchen sinks, shower trays or the like are being produced from a composite material which consists of a cured casting composition comprising a polymer matrix with embedded filler particles. A bacterial or viral load may arise particularly in the kitchen or bath area, since it is there, for example, that foodstuffs are handled, it is often damp, or a number of people are resident, and consequently special hygiene measures are important there. Although a high degree of cleanness can be achieved through frequent cleaning and/or disinfection, it is not always possible to carry out appropriate cleaning of the articles such as the kitchen sink or the shower tray or bathtub at every point.

### SUMMARY OF THE INVENTION

The problem addressed by the invention, therefore, is that of specifying a casting composition which allows the production of shaped composite parts which are improved in terms of keep-clean properties.

To solve this problem, the invention provides a thermosettable casting composition, with a polymeric binder and filler particles incorporated therein, a feature of which is that the casting composition comprises at least one essential oil.

The casting composition of the invention comprises at least one essential oil, which gives the casting composition and also the shaped article produced from it an at least antibacterial quality, but more particularly an antimicrobial quality as well, resulting in bacteria or viruses located on the article no longer being able to multiply, and dying.

Essential oils may represent an alternative strategy for conferring antimicrobial activity on a variety of objects. For example, lemongrass oil (Cymbopogen citratus) possesses pharmacological properties, including antiparasitic, antioxidant, antimicrobial, and anti-inflammatory properties (in this regard, see Li M., Liu B., Bernigaud Ch., et al., (2020) Plos Neglected Tropical Diseases, 6:1). A different study (Tavares T. D., Antunes J. C., Padrão J., et al., (2020) Antibiotics 9:314) showed an excellent antimicrobial effect of tea tree oil (TTO), of cinnamon tree oil (CLO) and of niaouli oil (NO) on the four widespread bacteria Staphylococcus aureus, Staphylococcus epidermidis, Escherichia coli, and Pseudomonas aeruginosa, this effect being achieved at lower concentrations than for silver nanoparticles. EP 2 575 452 A1 describes an antimicrobial composition based on essential oils which is able to reduce the antimicrobial activity of a solid, liquid or surrounding airspace when it is employed externally.

It has now surprisingly emerged that essential oils can be incorporated into a casting composition of this kind, and give the casting composition a corresponding antibacterial (to counter bacteria) and/or antimicrobial (additionally to counter viruses and fungi) quality. They can, therefore, be mixed into the polymeric binder together with the filler particles and any additional adjuvants such as a crosslinker or the like, and are able to distribute themselves homogeneously therein. Surprisingly this casting composition can also be processed correspondingly for the production of moldings such as a kitchen sink or a shower tray or base, this being accomplished by a thermal shaping operation in which the casting composition is placed into a mold and heated to an elevated temperature for the polymerization of the binder matrix, held there for a certain time, and thereafter cooled. It was found surprisingly that during the temperature procedure the essential oil neither evaporates nor changes or loses its antibacterial or antimicrobial qualities. It is distributed homogeneously in the molding, which therefore automatically itself has a corresponding antibacterial or antimicrobial quality.

As a result of this quality on the part of the molding, the molding has, so to speak, a kind of “self-cleaning property”, as it is furnished antibacterially or antimicrobially and on its surface, therefore, germs and/or bacteria and/or viruses are unable to multiply and, furthermore, are killed. Since this property is a property of the molding material itself, it is present accordingly on the entire surface, and so cleaning or killing takes place also at locations where no additional cleaning product is present. It is therefore possible to achieve a marked improvement in hygiene in the kitchen area or bath area or sanitary area more generally.

As well as the possibility of the casting composition containing only one essential oil, it may also comprise a mixture of two or more essential oils. This makes it possible, so to speak, to combine different properties of different essential oils by means of such a mixture, and to furnish the casting composition and, ultimately, the cast molding with a broad-spectrum antibacterial or antimicrobial quality.

As possible essential oils a variety of oils can be used. The essential oil or the two or more essential oils forming the mixture are selected preferably, though not conclusively, from cinnamon oil, clove oil, allspice oil, thyme oil, oregano oil, rosemary oil, citronella oil, geranium oil, lemongrass oil, eucalyptus oil or peppermint oil.

The amount or the fraction of the essential oil or of the oil mixture ought to be in the range of 0.05-5 wt %, based on the casting composition. This means that even a very low oil fraction is sufficient to bring about a marked improvement in the properties of the molding. The oil fraction or oil mixture fraction ought preferably to be 0.1-4 wt %, and with particular preference the fraction ought to be between 0.3-3 wt %.

Kitchen sinks and sanitaryware items can be manufactured in different ways and using different casting compositions. A variety of possibilities are described for example in DE 38 32 351 A1, DE 10 2004 055 365 A1 or DE 10 2019 125 777.8.

Casting compositions of this kind are filled, polymerized compositions based on monomers and inorganic fillers. The polymerizable compositions of DE 38 32 351 A1 consist, for example, of 74 to 76 wt % of crystalline silica sand, 24 to 26 wt % of a solution of polymethyl methacrylate in methyl methacrylate, the fraction of the polymethyl methacrylate in this solution being 18 to 25%, 1.2 wt % (based on the resin) of peroxide, auxiliaries, and 2 wt % of a crosslinker.

The casting composition known from DE 10 2004 055 365 A1 differs from the earlier casting compositions in the amount of the crosslinker, which is increased in the extreme. The fraction of the crosslinker is at least 10 wt %, based on the fraction of the monomer in the binder solution. The patent application DE 10 2019 1251777.8 describes a kitchen sink made from quartz composite and from biobased monomers and crosslinkers which greatly reduce the carbon footprint.

Fundamentally, then, different casting compositions can be used for producing the shaped parts. It has emerged that they can constitute a basis for the casting composition of the invention.

In a first formulation, then, for example, the casting composition of the invention, as well as containing essential oil or oils, ought to have a fraction of the polymeric binder, based on the mass of the casting composition, of between 15-60 wt %, more particularly between 20-40 wt % and preferably between 25-35 wt %, and a fraction of the filler particles, based on the mass of the casting composition, of between 40-85%, more particularly between 60-80%, preferably between 65-75%.

The binder may comprise at least one monomer, preferably methyl methacrylate, and at least one polymer dissolved therein, preferably polymethyl methacrylate.

The casting composition may also comprise a crosslinker, more particularly trimethylolpropane trimethacrylate. In that case the fraction of the crosslinker may be at least 2 wt %, based on the fraction of the monomer of the binder, preferably at least 5 wt %, more particularly at least 10 wt %, and very preferably between 20-30 wt %. A casting composition having a lower crosslinker content is known for example from DE 38 32 351 A1; a casting composition having a high crosslinker content is described in DE 102004 055 365 A1.

The filler particles are preferably selected from SiO2, Al2O3, TiO2, ZrO2, Fe2O3, ZnO, Cr2O5, carbon, metals or metal alloys, or are mixtures thereof, where the filler particles preferably have a particle size of 0.010 to 8000 μm, more preferably 0.05 to 3000 μm, and more particularly 0.1 to 1300 μm. These inorganic filler particles may have a grain size of between 0.01 mm and 2 mm or an aspect ratio of length to width of 1.0 to 1000 (length:width of the individual particles).

One alternative provides for a very largely biological or biobased thermosettable casting composition, comprising:
(a) one or more monofunctional and one or more polyfunctional acrylic and/or methacrylic biomonomers of plant or animal origin,
(b) one or more polymers or copolymers selected from polyacrylates, polymethacrylates, polyols, polyesters of recycled material or of plant or animal origin,
(c) inorganic filler particles of natural origin,

where constituents a) and b) form the polymeric binder, and

where, in addition to the fraction of the essential oil or oils, the fraction of the monofunctional and polyfunctional acrylic and methacrylic biomonomer or biomonomers is 10-40 wt %, the fraction of the polymer or polymers or copolymer or copolymers is 1-16 wt % and the fraction of the inorganic filler particles is 44-89 wt %.

A feature of this casting composition of the invention, in addition to the essential oil or oils, is that it consists to a large extent, if not indeed to an extent of 100%, of biological or natural materials, particularly in relation to the crosslinking substances used. Hence in accordance with the invention the monofunctional and polyfunctional acrylic and methacrylic biomonomers used are exclusively of plant or animal origin. In this case, therefore, no petrochemically derived polymers are employed. A biomonomer is a monomer of a biopolymer. The term “polyfunctional” encompasses biomonomers having a functionality of two, three and higher.

The polymers or copolymers used are preferably likewise of pure plant or animal origin, meaning that these substances as well are not of petrochemical origin. Here, however, as an alternative to the use of substances of plant/animal origin, a further possibility is to use polymers or copolymers from recycled material. While this material is usually petrochemical in origin, no virgin material is being used; instead, an existing, but recycled, material is being re-used, this being likewise advantageous from environmental standpoints. Since the biomonomers make up the larger fraction on the polymer side, alongside the inorganic fillers used which are likewise of natural origin, a large proportion of petrochemical-based existing substances used have been replaced within the casting composition of the invention by biomaterial in the form of the biomonomers, even when recycled material is used. Preferably, of course, polymers and/or copolymers of purely plant or animal origin are also used, thus producing in that case a casting composition consisting 100% of natural materials, since, as described, the fillers as well are of purely natural origin. Hence the molding produced from the casting composition of the invention, therefore, is a biomolding, consisting predominantly or preferably entirely of biological and hence natural materials. Producing the biocomposite material from the filler particles and the crosslinking materials, which are produced from renewable sources, reduces the consumption of petrochemically produced materials and therefore the consumption of petroleum, and is beneficial for the environment.

Since essential oil extracts are from aromatic plants and contain around 20-60 components in quite different concentrations, the oil fraction as well is biobased and therefore fits very well into this biological formulation of this casting composition.

In spite of the use of predominantly or exclusively natural materials for producing the casting composition, including the fraction of the essential oil or oils, or the molding, in other words, for example, a kitchen sink, it has surprisingly emerged that the molding exhibits very good, and in some cases, indeed, better mechanical properties, particularly in relation to impact toughness or scratch resistance, by comparison with a known casting composition produced from crosslinking materials obtained petrochemically, or a molding of that kind. Adding to these improved properties are the outstanding hygienic properties resulting from the antibacterial or antimicrobial qualities of the casting composition and hence of the molding. A casting composition of this kind, but without addition of essential oil(s), is from DE 10 2019 125 777.8.

A third variant of a casting composition comprises, in addition to the fraction of essential oil or oils:
(a) one or more monofunctional and one or more polyfunctional acrylic and/or methacrylic biomonomers of plant or animal origin,
(b) one or more polymers or copolymers selected from polyacrylates, polymethacrylates, polyols, polyesters of recycled material or of plant or animal origin,
(c) inorganic filler particles of natural origin,
where constituents a) and b) form the polymeric binder, and
where the fraction of the monofunctional and polyfunctional acrylic and methacrylic biomonomer or biomonomers is 10-40 wt %, the fraction of the polymer or polymers or copolymer or copolymers is 1-16 wt % and the fraction of the inorganic filler particles is 44-89 wt %.

A feature of this third casting composition formulation of the invention is that it consists to a large part of biological or natural materials, especially in relation to the crosslinking substances used. In accordance with the invention a mixture of different monofunctional monomers is used. In accordance with the invention the mixture of the monofunctional acrylic and methacrylic monomers that is used consists in part of recycled material and in part of monomers of plant or animal origin, with at least one monomer being recycled and at least one monomer being biobased, in other words of plant or animal origin. In this case, therefore, virtually no petrochemically derived polymers are employed, apart from the recycled fraction, which also, however, may consist of recycled biobased material. In any case, no petrochemically based virgin material is used in the scope of the recycled monofunctional monomer fraction. Polyfunctional monomers used are exclusively monomers of plant or animal origin. Insofar as monomers, whether monofunctional or polyfunctional monomers, of plant or animal origin are used, they may be referred to as “biomonomers”, with a biomonomer being a monomer of a biopolymer. The term “polyfunctional” encompasses biomonomers with a functionality of two, three and higher.

The polymers or copolymers used are preferably likewise of pure plant or animal origin, meaning that these substances as well are not of petrochemical origin. Here, however, as an alternative to the use of substances of plant/animal origin, a further possibility is to use polymers or copolymers from recycled material. While this material is usually petrochemical in origin, no virgin material is being used; instead, an existing, but recycled, material is being re-used, this being likewise advantageous from environmental standpoints. By using biomonomers and recycled material, petrochemical-based existing substances used have been completely replaced within the casting composition of the invention, even in the binder, by sustainable materials. Preferably, of course, polymers and/or copolymers of purely plant or animal origin are also used, thus producing in that case a casting composition consisting entirely of natural materials, apart from the monofunctional recycled monomer fraction, since, as described, the fillers as well are of purely natural origin. Hence the molding produced from the casting composition of the invention, therefore, is a biomolding, consisting predominantly of biological and hence natural materials. Producing the biocomposite material from the filler particles and the crosslinking materials, which are produced from renewable sources, reduces the consumption of petrochemically produced materials and therefore the consumption of petroleum, and is beneficial for the environment.

Here as well the essential oils used, as biological agents, contribute to the overall biological balance of the casting composition.

With this casting composition formulation as well it has surprisingly emerged that the molding exhibits very good mechanical properties, in some cases in fact better, particularly in relation to the impact toughness or the scratch resistance, by comparison with a known casting composition produced from petrochemically derived crosslinking materials, or with a molding of that kind. Here as well, an added factor is the outstanding antibacterial or antimicrobial properties via the essential oils included.

For both of the biobased casting compositions set out above it is the case that the weight ratio of monofunctional biomonomers to polyfunctional biomonomers ought to be 2:1 to 80:1, preferably 4:1 to 70:1, more particularly 5:1 to 60:1.

The monofunctional biomonomer or biomonomers are preferably selected from biobased acrylates, or where the monofunctional monomer or monomers are selected from recycled acrylates and acrylates of plant or animal origin, specifically n-butyl acrylate, methyl acrylate, ethyl acrylate, tert-butyl acrylate, isobutyl acrylate, isodecyl acrylate, dihydrodicyclopentadienyl acrylate, ethyl diglycol acrylate, heptadecyl acrylate, 4-hydroxybutyl acrylate, 2-hydroxyethyl acrylate, hydroxyethylcaprolactone acrylate, polycaprolactone acrylate, hydroxypropyl acrylate, lauryl acrylate, stearyl acrylate, tert-butyl acrylate, 2(2-ethoxy)ethyl acrylate, tetrahydrofurfuryl acrylate, 2-phenoxyethyl acrylate, ethoxylated 4-phenyl acrylate, trimethylcyclohexyl acrylate, octyldecyl acrylate, tridecyl acrylate, ethoxylated 4-nonylphenol acrylate, isobornyl acrylate, cyclic trimethylolpropane formal acrylate, ethoxylated 4-lauryl acrylate, polyester acrylate, stearyl acrylate hyperbranched polyester acrylate, melamine acrylate, silicone acrylate, epoxy acrylate, and from biobased methacrylates or from recycled methacrylates and methacrylates of plant or animal origin, specifically methyl methacrylate, ethyl methacrylate, n-butyl methacrylate, isobutyl methacrylate, tert-butyl methacrylate, behenyl methacrylate, ehenylpolyethylene glycol methacrylate, cyclohexyl methacrylate, isodecyl methacrylate, 2-ethylhexyl methacrylate, lauryl methacrylate, stearyl methacrylate, stearyl polyethylene glycol methacrylate, isotridecyl methacrylate, ureidomethacrylate, tetrahydrofurfuryl methacrylate, phenoxyethyl methacrylate, 3,3,5-trimethylcyclohexanol methacrylate, isobornyl methacrylate, methoxypolyethylene glycol methacrylate, glycedyl methacrylate, hexylethyl methacrylate, glycerol formal methacrylate, lauryltetradecyl methacrylate, C17,4-methacrylate.

The polyfunctional biomonomer or biomonomers are preferably selected from acrylates of plant or animal origin, specifically 1,6-hexanediol diacrylate, polyethylene glycol diacrylate, tetraethylene glycol diacrylate, tripropylene glycol diacrylate, polybutadiene diacrylate, 3-methyl-1,5-pentanediol diacrylate, ethoxylated bisphenol A diacrylate, dipropylene glycol diacrylate, ethoxylated hexanediol diacrylate, 1,10-decanediol diacrylate, ester diol diacrylate, alkoxylated diacrylate, tricyclodecanedimethanol diacrylate, propoxylated neopentyl glycol diacrylate, pentaerythritol tetraacrylate, trimethylolpropane triacrylate, di-trimethylolpropane tetraacrylate, tris (2-hydroxyethyl)isocyanurate triacrylate, di-pentaerythritol pentaacrylate, ethoxylated trimethylolpropane triacrylate, pentaerythritol triacrylate, propoxylated trimethylolpropane triacrylate, ethoxylated pentaerythritol tetraacrylate, propoxylated glyceryl triacrylate, aliphatic urethane diacrylate, aliphatic urethane hexaacrylate, aliphatic urethane triacrylate, aromatic urethane diacrylate, aromatic urethane triacrylate, aromatic urethane hexaacrylate, polyester hexaacrylate, epoxidized soybean oil diacrylate, and from the biobased polyfunctional methacrylates, specifically triethylene glycol dimethacrylate, ethylene glycol dimethacrylate, polyethylene glycol dimethacrylate, 1,4-butanediol dimethacrylate, diethylene glycol dimethacrylate, 1,6-hexanediol dimethacrylate, 1,10-decanediol dimethacrylate, 1,3-butylene glycol dimethacrylate, ethoxylated bisphenol A dimethacrylate, tricyclodecanedimethanol dimethacrylate, trimethylolpropane trimethacrylate.

The weight ratio of monofunctional and polyfunctional acrylates and methacrylates to the polymer or polymers or copolymer or copolymers ought to be 90:10 to 60:40, preferably 85:15 to 70:30.

The filler particles of the two biobased formulations are preferably selected from SiO₂, Al₂O₃, TiO₂, ZrO₂, Fe₂O₃, ZnO, Cr₂O₅, carbon, metals or metal alloys, or mixtures thereof, where the filler particles preferably have a particle size of 0.010 to 8000 μm, more preferably 0.05 to 3000 μm, and more particularly 0.1 to 1300 μm. The inorganic filler particles may have a grain size of between 0.01 mm and 2 mm or an aspect ratio of length to width of 1.0 to 1000 (length:width of the individual particles).

The casting composition of the invention ought fundamentally to have a viscosity which allows injection into a mold.

As well as the casting composition of the invention, the invention further relates to a molding produced using a thermosettable casting composition. Depending on the casting composition used, in relation to the components of the composition other than the essential oil or oils, the molding produced may be more or less biobased. If a biobased casting composition is used, it is even possible to produce a molding consisting 100% of natural, biological substances, and thus a biocomposite element, in other words, for example, a biocomposite kitchen sink or the like.

Different types of molding may be produced here. The molding may, for instance, be a kitchen sink, a shower tray, a washstand, a bathtub, a worktop or a floor, wall or ceiling panel, with this enumeration not being conclusive.

The invention further relates to a method for producing a molding of the type described above, in which a casting composition of the type likewise described above is used, and is placed into a mold, in which it is polymerized at a temperature elevated relative to room temperature, after which the polymerized molding is taken from the mold and cooled.

The temperature in this case ought during the polymerization to be between 60-140° C., preferably between 75-130° C. and more particularly 80-110° C.

Furthermore, the holding time, during which the casting composition remains in the mold for polymerization, ought to be between 15-50 min, preferably 20-45 min and more particularly 25-35 min.

In the present invention, the kitchen sinks or sanitaryware items have a content of essential oils in the material of the casting composition in a concentration of 0.05 wt % or more, up to a maximum of 5 wt %. Essential oils are extracts from aromatic plants. Essential oils contain around 20-60 components in very different concentrations. The most frequent constituents are terpenes, aromatic and aliphatic components (in particular, alcohols, esters, ethers, aldehydes, ketones, lactones, phenols and phenol ethers (in this regard see Bakkali F., Averbeck. S., Averbeck D., et al. (2008) Food Chem. Toxicol. 46:446)). These substances may enter into a strong chemical or physical bond with the components of the sink (e.g., silica sand, which has numerous hydroxyl functions on the surface), and consequently the effective antimicrobial properties of the essential oils lead to corresponding properties on the part of the molding produced from the casting composition of the invention, this being the case even at low concentrations.

Because the molecules of the essential oils are incorporated uniformly into the casting to composition and are therefore distributed over the entire volume of the kitchen sink and of the sanitaryware item, this means that the back of the kitchen sink or of the sanitaryware item likewise has an antimicrobial surface. Furthermore, any abrasive treatment, as frequently occurs in the kitchen or in the sanitary room, will therefore not reduce the antimicrobial effect.

Given below are a number of examples of the efficacy of the casting composition of the invention and hence of the moldings of the invention in curtailing various bacteria.

### EXAMPLE 1

Composition of a red-colored kitchen sink with and without antibacterial properties (amounts in wt %):

| | Sink for control | |
|---|---|---|
| | sample, without | Sink of the |
| | added essential oil | invention |
| PMMA copolymer | 4.8 | 4.8 |
| (Lucite International) | | |
| Methyl methacrylate | 19.2 | 19.1 |
| (Lucite International) | | |
| Silica sand filler 0.05-0.3 mm | 68.5 | 68.2 |
| (Dorfner GmbH) | | |
| Trimethylolpropane | 5.4 | 5.3 |
| trimethacrylate (Arkema) | | |
| Zinc stearate | 0.3 | 0.3 |
| (Magnesia GmbH) | | |
| Peroxides | 0.4 | 0.4 |
| (Rergan GmbH) | | |
| Pigment Red | 1.3 | 1.3 |
| (Lanxess AG) | | |
| BYK 410 antisettling agent | 0.1 | 0.1 |
| (BYK-Chemie GmbH) | | |
| Essential oil (Life | — | 0.5 |
| Materials Technology LTD) | | |

The mixture for producing the polymer matrix is prepared by dissolving the polymer in the methyl methacrylate. For the sink of the invention with at least antibacterial properties, additionally, the essential oil of peppermint (Life CN/AB-20-2U) was incorporated with the crosslinker for 30 minutes with stirring. The respective final casting composition is placed in a mold, for producing kitchen sinks with a basin with a bottom and surrounding side walls, and polymerization takes place thermally: starting from an ambient temperature of 20-30° C., the material is polymerized to completion by means of a heating ramp up to 90-120° C. in a mold as described in patent DE 38 32 351, with the average time being between 20 and 40 minutes, depending on the nature of the casting composition and on the time taken for the mold to heat up fully.

### EXAMPLE 2

Composition of a black-colored kitchen sink with and without antibacterial properties (amounts in wt %):

| | Sink for control | Sink II | Sink III |
|---|---|---|---|
| | sample, without | of the | of the |
| | added essential oil | invention | invention |
| PMMA copolymer | 4.7 | 4.7 | 4.7 |
| (Lucite International) | | | |
| Methyl methacrylate | 19.5 | 19.25 | 19.2 |
| (Lucite International) | | | |
| Silica sand filler 0.05- | 69.4 | 69.0 | 68.8 |
| 0.3 mm | | | |
| (Dorfner GmbH) | | | |
| Trimethylolpropane | 4.7 | 4.6 | 4.6 |
| trimethacrylate | | | |
| (Arkema) | | | |
| Zinc stearate (Magnesia | 0.4 | 0.4 | 0.4 |
| GmbH) | | | |
| Peroxides | 0.4 | 0.4 | 0.4 |
| Pergan GmbH | | | |
| Pigment Black (Orion | 0.7 | 0.7 | 0.7 |
| Engineered Carbon) | | | |
| BYK D410 antisettling | 0.2 | 0.2 | 0.2 |
| agent | | | |
| (BYK-Chemie GmbH) | | | |
| Essential oil | — | 0.75 | 1.0 |
| (Life Materials | | | |
| Technology Ltd) | | | |

For the material used, the production process is similar to that described in example 1, with the difference that a different essential oil was used as antibacterial/antimicrobial additive. For example 2, peppermint oil (Life CN/AB-50-2U, Life Materials Technology LTD) was used.

Determination of the Antibacterial Properties of the Surface of the Kitchen Sink from Examples 1-2.

The determination was carried out according to ISO 22196:2011.

6 samples with dimensions 5×5 cm were cut from the bottom of each test sink, meaning that a total of 30 samples or test specimens were taken from the three sinks. The test specimens were inoculated with the test microbe over an area of 4×4 cm on the testing side (smooth side=facing or working side). Prior to the test, the bacteria were transferred from the stock culture to the culture medium and incubated for 16 h at (35±1°) C. From this culture, using a sterile inoculation loop, bacteria were transferred to fresh culture medium and incubated for a further 16 hours at (35±1°) C.

Preincubated bacteria were transferred into a neutralizing solution of 1/500 NB. The test bacteria were uniformly distributed and the number of bacteria was counted using a Petroff-Hausser counting chamber by means of direct microscope observation (SWIFT SW380T Optical Microscope). Following accumulation to the respective concentrations, these solutions were used as test inoculum. Each test sample was placed into the separate sterile Petri dish. Using a 0.4 ml pipette, the test inoculum was transferred to the test surfaces. Immediately after inoculation with neutralizing solution, the bacteria were washed off from some of the test samples and the microbe count (U₀) was determined. The test inoculum was covered with a polyethylene film having a thickness of 0.07±0.01 mm, in order to prevent absorption of moisture by bacteria. The Petri dishes containing the inoculated test samples were incubated for 24 hours at a temperature of (35±°) C. and a relative atmospheric humidity of 90%. Thereafter they too were washed with neutralizing solution and a determination was made of the microbe count of the test samples (Uₜ and Aₜ).

The test was carried out as a fourfold determination. Prior to the test, the test samples were cleaned with 70% ethanol.

Testing of the bacteria: Staphylococcus aureus (DSM 799)
Escherichia coli (DSM 1576).
   Test conditions: T=36±1° C.; 24 h; atmospheric humidity more than 90%.
   Neutralizing solution: BD Difco™ Neutralizing Broth
   Culture medium: Plate count agar
   Typical Calculation for the Black-Colored Kitchen Sink from Example 2:

| | | | Number of | Number of | Number of | | |
|---|---|---|---|---|---|---|---|
| | | | bacteria | bacteria | bacteria | | |
| | | | recovered | recovered | recovered | | |
| | | | from the | from the | from | | |
| | | | control | control | the test | | |
| | | | sample | sample | specimen | | |
| | | Initial | after | after | after | | |
| | | inoculum | 0 hours' | 24 hours' | 24 hours' | | |
| | Bacterial | concen- | contact | contact | contact | Anti- | |
| Micro- | concen- | tration | time | time | time | bacterial | |
| organism | tration | (CFU/ | (CFU/ | (CFU/ | (CFU/ | activity | % |
| tested | (CFU/ml) | specimen) | specimen) | specimen) | specimen) | (R) | reduction |
| Staphylo- | 250 000 | 100 000 | 100 000 | 520 000 | 65 000 | 0.9 | 87.50 |
| coccus | | (5.0 log) | (5.0 log) | (5.7 log) | (4.8 log) | | |
| aureus | | | | | | | |
| Escheri- | 370 000 | 150 000 | 130 000 | 4 100 000 | 90 | 4.6 | 99.99 |
| chia coli | | (5.2 log) | (5.1 log) | (6.6 log) | (2.0 log) | | |

Calculation of the antibacterial activity R:

R=(Uₜ−U₀)−(Aₜ−U₀)

where:
R—antibacterial activity
U₀—mean value of the logarithm of the number of viable bacteria in cells/cm2 obtained immediately after the incubation from untreated samples
Uₜ—mean value of the logarithm of the number of viable bacteria in cells/cm2 from untreated samples immediately after 24 h
Aₜ—mean value of the logarithm of the number of viable bacteria in cells/cm2 obtained from treated samples directly after 24 h
Calculation of the % age reduction

$$\% Reduction = \frac{A - B}{A} \times 100$$

where:
A=the number of bacteria recovered from the control after 24 hours' contact time (CFU/specimen)
B=the number of bacteria recovered from the tested sample after 24 hours' contact time (CFU/specimen)

### The Antibacterial Properties Found for the Kitchen Sinks of Examples 1-2:

| | Gram- | | Gram- | |
|---|---|---|---|---|
| | positive | % | negative | % |
| Specimen | bacteria | reduction | bacteria | reduction |
| Red - LIFE | ++ | 98.3 | + | 83.3 |
| CN/AB-20-2U | | | | |
| Red (control) | — | 0 | — | 0 |
| Black - LIFE | + | 87.5 | +++ | >99.99 |
| CN/AB-50-2U | | | | |
| (0.75 wt %) | | | | |
| Black (control) | — | 0 | — | 0 |
| Black - LIFE | + | 86.3 | +++ | >99.99 |
| CN/AB-50-2U | | | | |
| (1.0 wt %) | | | | |
| Black (control) | — | 0 | — | 0 |

It is apparent that the moldings of the invention exhibit outstanding properties in relation to reducing bacteria within a short time.

### BRIEF DESCRIPTION OF THE DRAWING

In the drawing:

FIG. 1 shows E. coli testing results; and

FIGS. 2 and 3 show roughness measurements.

### DETAILED DESCRIPTION OF THE INVENTION

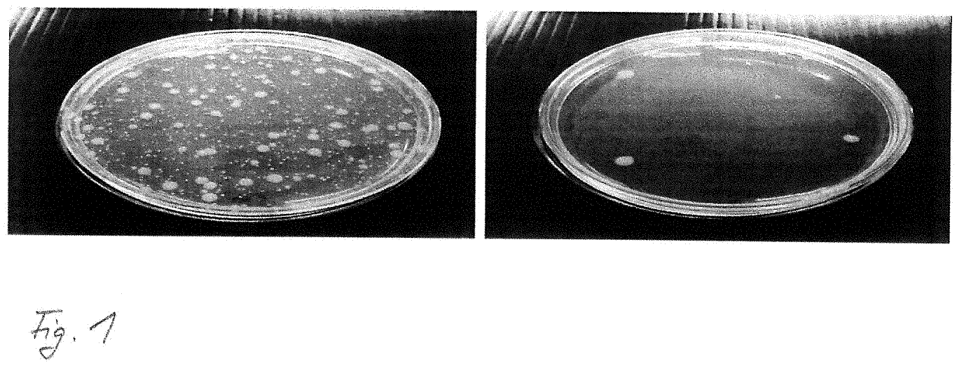

FIG. 1 shows the Escherichia coli colony after 24-hour testing of the black sinks from example 2 and the control sample. E. coli colonies were washed off with the neutralizing solution from the sample of the invention and from the control sample, and were collected in the Petri dishes. On the left-hand side is a Petri dish with the E. coli bacterial colony after the testing of the control sample. On the right-hand side is a significant reduction apparent in the bacterial colony after the testing of the sample of the invention. Only very few, isolated colonies are apparent, whereas the control sample shows a high colonization.

The improvement in the antimicrobial properties in the present invention has no consequences for the texture of the surface of the kitchen sink basin or of the sanitaryware articles.

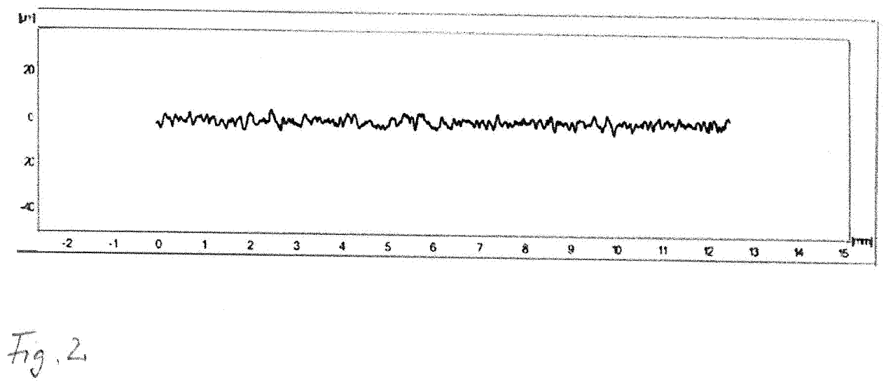

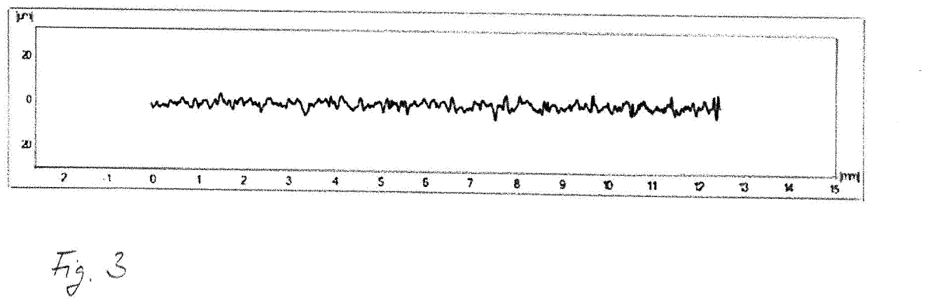

FIGS. 2 and 3 show the roughness measurement with a Mitutoyo SJ-500 P instrument on a control sink (FIG. 2) and on a sink of the invention (FIG. 3). The measurement distance in mm is plotted along the abscissa, and the roughness in μm along the ordinate.

The surfaces of the control sink and of the sink of the invention with the LIFE CN/AB-50-2U, (1 wt %) have the roughness maximum (Rzmax) in the region of 5 to 10 μm. The maximum roughness of the control sink is Rzmax(control)=7.4 μm, while that of the sink of the invention is Rzmax(antibac)=9.3 μm. Furthermore, the addition of the essential oils has no influence on the mechanical and thermal performance of the product produced.

While specific embodiments of the invention have been shown and described in detail to illustrate the inventive principles, it will be understood that the invention may be embodied otherwise without departing from such principles.

We claim:

1. A thermosettable casting composition, with a polymeric binder and filler particles incorporated therein, wherein the casting composition further comprises at least one essential oil.

2. The thermosettable casting composition according to claim 1, wherein the casting composition comprises a mixture of two or more essential oils.

3. The thermosettable casting composition according to claim 1, wherein the essential oil or the two or more essential oils forming the mixture are selected from cinnamon oil, clove oil, allspice oil, thyme oil, oregano oil, rosemary oil, citronella oil, geranium oil, lemongrass oil, eucalyptus oil or peppermint oil.

4. The thermosettable casting composition according to claim 1, wherein the fraction of the essential oil or oils is in the range of 0.05-5 wt %, preferably 0.1-4 wt %, more preferably 0.3-3 wt %.

5. The thermosettable casting composition according to claim 1, wherein the fraction of the polymeric binder, based on the mass of the casting composition, is between 15-60 wt %, more particularly between 20-40 wt % and preferably between 25-35 wt %, and the fraction of the filler particles, based on the mass of the casting composition, is between 40-85%, more particularly between 60-80%, preferably between 65-75%.

6. The thermosettable casting composition according to claim 1, wherein the binder comprises at least one monomer, preferably methyl methacrylate, and at least one polymer dissolved therein, preferably polymethyl methacrylate.

7. The thermosettable casting composition according to claim 1, wherein it comprises a crosslinker, more particularly trimethylolpropane trimethacrylate.

8. The thermosettable casting composition according to claim 6, wherein the fraction of the crosslinker is at least 2 wt %, based on the fraction of the monomer of the binder, preferably at least 5 wt %, more particularly at least 10 wt %, and more preferably between 20-30 wt %.

9. The thermosettable casting composition according to claim 1, wherein the filler particles are selected from SiO2, Al2O3, TiO2, ZrO2, Fe2O3, ZnO, Cr2O5, carbon, metals or metal alloys, or mixtures thereof, the filler particles preferably having a particle size of 0.010 to 8000 μm, more preferably 0.05 to 3000 μm, and more particularly 0.1 to 1300 μm.

10. The thermosettable casting composition according to claim 1, comprising:
(a) one or more monofunctional and one or more polyfunctional acrylic and/or methacrylic biomonomers of plant or animal origin,
(b) one or more polymers or copolymers selected from polyacrylates, polymethacrylates, polyols, polyesters of recycled material or of plant or animal origin,
(c) inorganic filler particles of natural origin,
where constituents a) and b) form the polymeric binder, and
where the fraction of the monofunctional and polyfunctional acrylic and methacrylic biomonomer or biomonomers is 10-40 wt %, the fraction of the polymer or polymers or copolymer or copolymers is 1-16 wt % and the fraction of the inorganic filler particles is 44-89 wt %.

11. The thermosettable casting composition according to claim 1, comprising:
(a) one or more monofunctional and one or more polyfunctional acrylic and/or methacrylic biomonomers of plant or animal origin,
(b) one or more polymers or copolymers selected from polyacrylates, polymethacrylates, polyols, polyesters of recycled material or of plant or animal origin,
(c) inorganic filler particles of natural origin,
where constituents a) and b) form the polymeric binder, and
where the fraction of the monofunctional and polyfunctional acrylic and methacrylic biomonomer or biomonomers is 10-40 wt %, the fraction of the polymer or polymers or copolymer or copolymers is 1-16 wt % and the fraction of the inorganic filler particles is 44-89 wt %.

12. The thermosettable casting composition according to claim 10, wherein the weight ratio of monofunctional biomonomers to polyfunctional biomonomers is 2:1 to 80:1, preferably 4:1 to 70:1, more particularly 5:1 to 60:1.

13. The thermosettable casting composition according to claim 10, wherein the monofunctional biomonomer or biomonomers are selected from biobased acrylates or where the monofunctional monomer or monomers are selected from recycled acrylates and acrylates of plant or animal origin, specifically n-butyl acrylate, methyl acrylate, ethyl acrylate, tert-butyl acrylate, isobutyl acrylate, isodecyl acrylate, dihydrodicyclopentadienyl acrylate, ethyl diglycol acrylate, heptadecyl acrylate, 4-hydroxybutyl acrylate, 2-hydroxyethyl acrylate, hydroxyethylcaprolactone acrylate, polycaprolactone acrylate, hydroxypropyl acrylate, lauryl acrylate, stearyl acrylate, tert-butyl acrylate, 2(2-ethoxy)ethyl acrylate, tetrahydrofurfuryl acrylate, 2-phenoxyethyl acrylate, ethoxylated 4-phenyl acrylate, trimethylcyclohexyl acrylate, octyldecyl acrylate, tridecyl acrylate, ethoxylated 4-nonylphenol acrylate, isobornyl acrylate, cyclic trimethylolpropane formal acrylate, ethoxylated 4-lauryl acrylate, polyester acrylate, stearyl acrylate hyperbranched polyester acrylate, melamine acrylate, silicone acrylate, epoxy acrylate, and from biobased methacrylates or from recycled methacrylates and methacrylates of plant or animal origin, specifically methyl methacrylate, ethyl methacrylate, n-butyl methacrylate, isobutyl methacrylate, tert-butyl methacrylate, behenyl methacrylate, ehenylpolyethylene glycol methacrylate, cyclohexyl methacrylate, isodecyl methacrylate, 2-ethylhexyl methacrylate, lauryl methacrylate, stearyl methacrylate, stearyl polyethylene glycol methacrylate, isotridecyl methacrylate, ureidomethacrylate, tetrahydrofurfuryl methacrylate, phenoxyethyl methacrylate, 3,3,5-trimethylcyclohexanol methacrylate, isobornyl methacrylate, methoxypolyethylene glycol methacrylate, glycedyl methacrylate, hexylethyl methacrylate, glycerol formal methacrylate, lauryltetradecyl methacrylate, C17,4-methacrylate.

14. The thermosettable casting composition according to claim 10, wherein the polyfunctional biomonomer or biomonomers are selected from acrylates of plant or animal origin, specifically 1,6-hexanediol diacrylate, polyethylene glycol diacrylate, tetraethylene glycol diacrylate, tripropylene glycol diacrylate, polybutadiene diacrylate, 3-methyl-1,5-pentanediol diacrylate, ethoxylated bisphenol A diacrylate, dipropylene glycol diacrylate, ethoxylated hexanediol diacrylate, 1,10-decanediol diacrylate, ester diol diacrylate, alkoxylated diacrylate, tricyclodecanedimethanol diacrylate, propoxylated neopentyl glycol diacrylate, pentaerythritol tetraacrylate, trimethylolpropane triacrylate, di-trimethylolpropane tetraacrylate, tris (2-hydroxyethyl)isocyanurate triacrylate, di-pentaerythritol pentaacrylate, ethoxylated trimethylolpropane triacrylate, pentaerythritol triacrylate, propoxylated trimethylolpropane triacrylate, ethoxylated pentaerythritol tetraacrylate, propoxylated glyceryl triacrylate, aliphatic urethane diacrylate, aliphatic urethane hexaacrylate, aliphatic urethane triacrylate, aromatic urethane diacrylate, aromatic urethane triacrylate, aromatic urethane hexaacrylate, polyester hexaacrylate, epoxidized soybean oil diacrylate, and from the biobased polyfunctional methacrylates, specifically triethylene glycol dimethacrylate, ethylene glycol dimethacrylate, polyethylene glycol dimethacrylate, 1,4-butanediol dimethacrylate, diethylene glycol dimethacrylate, 1,6-hexanediol dimethacrylate, 1,10-decanediol dimethacrylate, 1,3-butylene glycol dimethacrylate, ethoxylated bisphenol A dimethacrylate, tricyclodecanedimethanol dimethacrylate, trimethylolpropane trimethacrylate.

15. The thermosettable casting composition according to claim 10, wherein the weight ratio of monofunctional and polyfunctional acrylates and methacrylates to the polymer or polymers or copolymer or copolymers is 90:10 to 60:40, preferably 85:15 to 70:30.

16. The thermosettable casting composition according to claim 1, wherein the filler particles are selected from SiO2, Al2O3, TiO2, ZrO2, Fe2O3, ZnO, Cr2O5, carbon, metals or metal alloys, or mixtures thereof, where the filler particles preferably have a particle size of 0.010 to 8000 μm, preferably 0.05 to 3000 μm, and more particularly 0.1 to 1300 μm.

17. The thermosettable casting composition according to claim 1, wherein it has a viscosity which permits injection into a mold.

18. A molding produced using a thermosettable casting composition according to claim 1.

19. The molding according to claim 18, wherein the molding is a kitchen sink, a shower tray, a washstand, a bathtub, a worktop or a floor, wall or ceiling panel.

20. A method for producing a molding, in which a casting composition according to claim 1 is used and is placed into a mold in which it is polymerized at a temperature elevated relative to room temperature, after which the polymerized molding is taken from the mold and cooled.

21. The method according to claim 20, where the temperature during the polymerization is between 60-140° C., preferably between 75-130° C. and more particularly 80-110° C.

22. The method according to claim 20, wherein the holding time during which the casting composition remains in the mold for polymerization is between 15-50 min, preferably 20-45 min and more particularly 25-35 min.
